(19) United States
(12) Patent Application Publication
(10) Pub. No.: US 2016/0330042 A1
(43) Pub. Date: Nov. 10, 2016

(54) HOME AUTOMATION SYSTEM

(71) Applicant: David C. Andersen, Salt Lake City, UT (US)

(72) Inventor: David C. Andersen, Salt Lake City, UT (US)

(21) Appl. No.: 15/146,556

(22) Filed: May 4, 2016

Related U.S. Application Data
(60) Provisional application No. 62/156,771, filed on May 4, 2015.

(51) Int. Cl. H04L 12/28; H04L 29/08; G05B 19/042; G05B 15/02

(52) U.S. Cl. CPC H04L 12/282; G05B 15/02; H04L 67/12; G05B 19/0428; G05B 2219/2642; G05B 2219/2612

(57) ABSTRACT

A home automation system comprises a central processing unit controlling a network in communication with a plurality of smart devices comprising one or more of a switch or an outlet. Each smart device comprises a processor, a communication device in communication with the central processing unit via the network and a user interface for controlling or setting an operating parameter of the smart device.

### CROSS-REFERENCE TO RELATED APPLICATION

The present invention claims priority to U.S. Provisional Application Ser. No. 62/156,771 filed on May 4, 2015, the entirety of which is incorporated by this reference.

### FIELD OF THE INVENTION

The present invention relates generally to devices and systems for determining home automation and more specifically, to devices and systems that are configured to automatically and/or remotely operate lighting and other electrical appliances in a house or other residential or commercial building.

### STATE OF THE PRIOR ART

Home automation is the residential extension of building automation. It is automation of the home, housework or household activity. Home automation may include centralized control of lighting, HVAC (heating, ventilation and air conditioning), appliances, security locks of gates and doors and other systems, to provide improved convenience, comfort, energy efficiency and security. Home automation for the elderly and disabled can provide increased quality of life for persons who might otherwise require caregivers or institutional care.

The popularity of home automation has been increasing greatly in recent years due to much higher affordability and simplicity through smartphone and tablet connectivity. The concept of the “internet of things” has tied in closely with the popularization of home automation. The Internet of Things (IOT) is the network of physical objects or “things” embedded with electronics, software, sensors and connectivity to enable it to achieve greater value and service by exchanging data with the manufacturer, operator and/or other connected devices. Each thing is uniquely identifiable through its embedded computing system but is able to interoperate within the existing Internet infrastructure.

A home automation system integrates electrical devices in a house with each other. The techniques employed in home automation include those in building automation as well as the control of domestic activities, such as home entertainment systems, houseplant and yard watering, pet feeding, changing the ambiance “scenes” for different events (such as dinners or parties), and the use of domestic robots. Devices may be connected through a home network to allow control by a personal computer, and may allow remote access from the Internet. Through the integration of information technologies with the home environment, systems and appliances can communicate in an integrated manner, which results in convenience, energy efficiency and safety benefits.

Automated “homes of the future” have been staple exhibits for World's Fairs and popular backgrounds in science fiction. However, problems with complexity, competition between vendors, multiple incompatible standards, and the resulting expense have limited the penetration of home automation to homes of the wealthy, or ambitious hobbyists. The present invention provides a system for automating a home or other building in an easy and cost effective manner.

### BRIEF DESCRIPTION OF THE DRAWINGS

When considered in connection with the following illustrative figures, a more complete understanding of the present invention may be derived by referring to the detailed description. In the figures, like reference numbers refer to like elements or acts throughout the figures. Various embodiments of the present invention are shown and described in reference to the numbered drawings.

FIG. 1 is a schematic diagram of a network system including several devices in accordance with the principles of the present invention.

FIG. 2 is a schematic block diagram of a smart network system in accordance with the principles of the present invention.

FIG. 3 includes a smart switch, smart sensor, smart outlet and smart controller in accordance with the principles of the present invention.

FIG. 4 is a schematic block diagram of a smart network CPU and system in accordance with the principles of the present invention.

FIG. 5 is a schematic block diagram of a smart control CPU and system in accordance with the principles of the present invention.

FIG. 6 is a schematic block diagram of a smart sensor CPU and system in accordance with the principles of the present invention.

FIG. 7 is a schematic block diagram of a smart switch CPU and system in accordance with the principles of the present invention.

FIG. 8 is a schematic block diagram of a smart outlet CPU and system in accordance with the principles of the present invention.

FIG. 9 is a circuit diagram of a smart network in accordance with the principles of the present invention.

FIG. 10 is a circuit diagram of a smart switched outlet in accordance with the principles of the present invention.

FIG. 11 is a circuit diagram of a smart dimmer outlet in accordance with the principles of the present invention.

FIG. 12 is a circuit diagram of a smart sensor in accordance with the principles of the present invention.

FIG. 13 is a circuit diagram of a smart switch dimmer in accordance with the principles of the present invention.

FIG. 14 is a block diagram of a smart network system in accordance with the principles of the present invention.

FIG. 15 is a block diagram of a smart dimming switch in accordance with the principles of the present invention.

FIG. 16 is a block diagram of a smart outlet in accordance with the principles of the present invention.

FIG. 17 is a perspective side view of a smart light bulb adapter switch in accordance with the principles of the present invention.

FIG. 18 is a schematic diagram of a smart circuit breaker in accordance with the principles of the present invention.

It will be appreciated that the drawings are illustrative and not limiting to the scope of the invention, which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention. Elements and acts in the figures are illustrated for simplicity and have not necessarily been rendered according to any particular sequence or embodiment.

### DETAILED DESCRIPTION OF THE ILLUSTRATED EMBODIMENTS

The invention and associated drawings will now be discussed in reference to the numerals provided therein so as to enable one skilled in the art to practice the present invention. The drawings and descriptions are exemplary of various aspects of the invention and are not intended to narrow the scope of the appended claims. Unless specifically noted, it is intended that the words and phrases in the specification and the claims be given their plain, ordinary, and accustomed meaning to those of ordinary skill in the applicable arts. It is noted that the inventor can be his own lexicographer. The inventor expressly elects, as his own lexicographer, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. §112, ¶6. Thus, the use of the words “function,” “means” or “step” in the Detailed Description of the Invention or claims is not intended to somehow indicate a desire to invoke the special provisions of 35 U.S.C. §112, ¶6, to define the invention. To the contrary, if the provisions of 35 U.S.C. §112, ¶6 are sought to be invoked to define the inventions, the claims will specifically and expressly state the exact phrases “means for” or “step for” and the specific function (e.g., “means for filtering”), without also reciting in such phrases any structure, material or act in support of the function. Thus, even when the claims recite a “means for . . . ” or “step for . . . ” if the claims also recite any structure, material or acts in support of that means or step, or that perform the recited function, then it is the clear intention of the inventor not to invoke the provisions of 35 U.S.C. §112, ¶6. Moreover, even if the provisions of 35 U.S.C. §112, ¶6 are invoked to define the claimed inventions, it is intended that the inventions not be limited only to the specific structure, material or acts that are described in the illustrated embodiments, but in addition, include any and all structures, materials or acts that perform the claimed function as described in alternative embodiments or forms of the invention, or that are well known present or later-developed, equivalent structures, material or acts for performing the claimed function.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention. It should be noted that there are many different and alternative configurations, devices and technologies to which the disclosed inventions may be applied. Thus, the full scope of the inventions is not limited to the examples that are described below.

An intelligent home or other residential or commercial automation system according to the principles of the present invention may include a computer system and computer implemented method for determining lighting and/or appliance conditions.

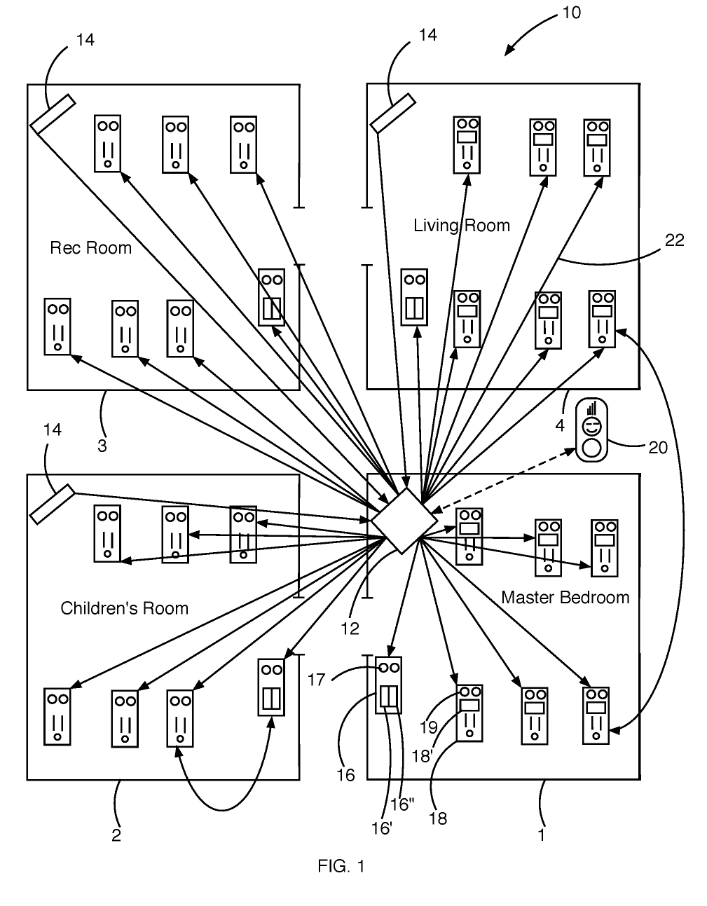

An example of a suitable operating environment in which various aspects of the invention may be implemented is shown in the schematic diagram in FIG. 1. The operating environment is only one example of a suitable operating environment and is not intended to suggest any limitation as to the scope of use or functionality of the invention. The operating environment may be comprised of one or more rooms 1-4 throughout which a network is established that allows communication to and between the various devices that are part of the “SmartNet SmartHouse Network.” The system 10, according to the principles of the present invention, is comprised of and primarily controlled by a main SmartNet controller 12, which may comprise a computing device, such as a personal computer or other computing device that may contain a processor, memory, a user interface and a display. The primary SmartNet central processing unit (CPU) 12 includes a networking feature that allows communication to and between the device 12 and the plurality of other devices dispersed throughout the rooms 1-4 that are in communication with the CPU 12 coupled to a computing device through a network 22 represented by arrows. The communication between the CPU12 and the other devices may be through wired or wireless communication networks. One or more networks may be in the form of a local area network (LAN) that has one or more of the well-known LAN topologies and may use a variety of different protocols, such as Ethernet. One or more of the networks may be in the form of a wide area network (WAN), such as the Internet. The CPU 12 and other devices may be connected to one or more of the networks via twisted pair wires, coaxial cable, fiber optics, radio waves or other media or devices. The term “network” as used herein and depicted in the drawings should be broadly interpreted to include not only systems in which remote databases are coupled together via one or more communication paths, but also stand-alone devices that may be coupled, from time to time, to such systems that have storage capability. Consequently, the term “network” includes not only a “physical network” but also a “content network,” which is comprised of the data attributable to a single entity, which resides across all physical networks.

The CPU 12 may be comprised of a processing unit and memory. The processing unit may be comprised of a conventional processor for executing computer-executable instructions. One skilled in the art will understand that the processor may be pre-programmed or hard-wired with computer-executable instructions, or the processor may be a general-purpose processor that executes or performs encoded instructions. The memory may be comprised of volatile and/or nonvolatile memory for storing, among other things, computer executable instructions. The computer-executable instructions may be arranged as modules that interact with other modules and devices in accordance with aspects of the invention.

As will each be described in more detail herein, the system 10 is comprised of a plurality of “smart” devices that may include smart sensors 14, smart switches 16 and smart outlets 18. That is, each room 1-4 may contain various smart devices that are controlled by the CPU 12 or by internal circuitry and components within each smart device. The term “smart” as used herein is intended to indicate that each smart device is capable of communicating with the CPU 12 of the system either directly or via communication with other smart devices in the system. As shown in FIG. 1, each sensor 14 is in direct communication with the CPU 12 via the network 22 (indicated by arrows) to send room and/or the status of each smart device within the room to the CPU 12. In addition, each of the smart devices can also communicate with one another. For example, a smart switch 16 may communicate with a smart outlet 18 and vise versa. In addition, a smart phone 20, or other computing device, such as a tablet or PC can be used to communicate with the CPU 12 and control each of the smart devices in the system 10 from a remote location that has access to the network 22.

The smart devices according to the principles of the present invention are unique in that each device in the system is capable of being operated by motion and/or voice control either simultaneously or independently. That is, each smart device may include both a microphone for voice recognition and control as well as a camera for motion and/or gesture control as described herein. These functions can be operated in tandem or separately as the user selects. In addition, each smart device can be operated autonomously with or without connection to the SmartNet network 22 so that a single smart device can operate and be controlled by a user according to user controlled settings of the smart device.

The CPU 12 is the core of the control of the system 10, although each smart device may be operated autonomously once programmed. In addition, while illustrated with a single CPU 12, the system 10 may include multiple CPU's 12 on the same network 22 in communication with one another. Other functional variants may also include that a smart sensor 14 of the present invention may serve to do distributed management and control and as a network server for both distributed backup and a redundancy system when multiple units are present. For example, each functional device, in the event of failure of a single smart device, can report back to another smart device to serve as a replacement in order to reconstruct, from other distributed information, the majority of the program information of the device that failed.

The CPU 12 may be in set in an auto update mode so that it will be possible for key elements of the system 10 to be updated as needed under secure control. The system also allows for a hierarchical topography, so that individual areas, or groups of common systems can be addressed as a unit. For example, the user can control multiple outlets and/or switches by requesting or selecting for example, “All light on” or “Dining room off.” The system 10 also include one or more interfaces to “Internet of Things” (IOT) standards so as to allow the complete system to be accessed and controlled by an authorized user over WAN connectivity.

One or more of the smart devices 12, 14 and 16 may include voice recognition capabilities and include a programming mode. Each of the smart devices can also communicate with the other smart devices in the system 10. That is, the smart switches and smart outlets in other rooms can be controlled by, for example, speaking the words “living room lights dim to 30%” in another room 3, at which time the lights in the living room 4 that are controlled by a smart switch 16 or smart outlet 18 will cause the lights in the living room 4 to dim to 30%. Other voice commands may include, for example, “master bedroom walk in motion control mode on.” The smart devices 16 and 18 in the master bedroom 1, will then be set to activate when the motion of a person walking into the room 1 is detected. Alarms can also be set with a voice command, such as “walk in motion control mode.”

The CPU 12 operates as a “processing hub” for all intra-device communications and commands, including voice commands. Moreover, the CPU 12 is also a processing hub for video frames from each Smart Switch or Smart Outlet that has video capability. The CPU 12 also includes all smart outlet functions. For voice control and programming mode, a user can press a button for a short duration (e.g., less than one second) to put the smart switch 16 into the voice control mode, at which time a multicolor LED 17 illuminates in a steady mode. The user can name the room and specific lamp, appliance or home entertainment system to be controlled by the particular Smart Switch or Smart Outlet. After an appliance is connected to a smart outlet 18, the user can say, for example, “living room stereo on,” and the smart outlet 18 to which the stereo system is electrically connected will cause the stereo system to receive power.

Each smart device also includes a timer. The user can then set the time for the specific smart device to activate, thereby causing whatever system is connected to the smart device, such as lights, entertainment systems, etc., to turn on. For example, the user can set the timer for the smart outlet 18 to which the living room stereo system is connected with a command such as “living room stereo on at 5:00 PM.”

The system also includes motion control capability and programmability. For example, by pressing a button for a longer duration (e.g., more than three seconds) on a smart switch 16 or smart outlet 18, the switch 16 or outlet 18 will go into a motion control mode, as indicated by a flashing LED 17. The user can then select a gesture of, for example, walking into a room to turn on a lamp, appliance or home entertainment system connected to the particular smart device. The user can then use another selected gesture, such as the motion of walking out of the room, cause the smart device to turn off the lamp, appliance or home entertainment system off.

In motion control mode, if a lamp, appliance, home entertainment system or other electrical device that is connected to a smart device of the system 10 is off, a user may turn it on by, for example, using a gesture of hand waving. That is, the smart devices that include a motion-activated feature can be programmed to recognize different movements (i.e., gestures) to cause the smart device to react in a certain way. For example, the smart device may turn off the lamp, appliance or entertainment system by, for example, detecting that the user has waved his/her hand in the same way that caused the smart device to activate, or in a different manner.

Other gestures may also be detectable. For example, to raise a light level in a lamp, a user may, for example, move a hand up vertically in front of the smart device to which the lamp is connected and, subsequently, dim the lamp by moving a hand down vertically in front of the smart device to which the lamp is connected.

The smart switches 16 of the present invention have various modes of operation. In manual mode, the up and down buttons 16′ and 16″ of the smart switch 16 can be used to raise or dim lighting levels. To activate voice control mode, a user can press both up and down buttons 16′ and 16″ simultaneously for a short duration (e.g., less than one second) to activate the voice control mode. A multicolor LED 17 will light up to indicate that the voice control mode is active.

In the voice control mode, the user can name the room or specific hardwired light and control lighting in that room by saying, for example, “living room lights on” or “dim lights to 40%.” Lighting or devices in other rooms can be controlled from different rooms by saying, for example, “basement lights out” or “recreation room TV off” that is communicated through any smart devices in one room through the CPU 12 out to another smart device in another room.

In the voice control mode, the user can also set a time for lights to come on by saying, for example, “timed lights on at 6:30 PM.” The user can also set the time for the lights to turn off by saying, for example, “timed lights off at 8:30 PM.”

In motion control programming mode, both buttons 16′ and 16″ on the smart switch 16 are simultaneously pressed for a longer duration (e.g., more than three seconds) to put the switch 16 into motion control mode. A flashing LED 17 indicates that the smart switch 16 is in motion control programming mode. In the programming mode, the user can select gestures of, for example, walking into the room to turn on the lights or leaving the room to turn the lights off. Other gesture selections may include turning on lights by waving a hand, turning off the lights by waving a hand in the same or a different way, raising a light level by moving a hand up vertically and dimming a light level by moving a hand down vertically.

The smart outlets 18 operate in a similar manner to the smart switches described above. To activate the voice control mode, a button 18′ on the smart outlet 18 is pressed for a short duration (e.g., less than one second), indicated by a steady LED 19. In the voice control mode, the user can name the room and specific lamp, appliance, home entertainment system or other electrical device connected to the smart outlet 18. Once named, a user can activate the smart outlet by saying, for example, “living room stereo on.” The user can also set a timer for the smart outlet 18. For example, the user can set the time for the specific home entertainment system to turn on by saying, for example, “living room stereo on at 5:00 PM.” The user can then, in a similar manner, set the time for the stereo to turn off.

In the motion control mode, the user presses the button 18′ on the smart outlet for a longer duration (e.g., more than three seconds) to activate the motion control mode, indicated by a flashing LED on the Smart Outlet. The user can then select, for example, the gesture of walking into the room to turn on an appliance connected to the Smart Outlet. The user can also select the gesture of walking out of the room to turn the appliance off. Alternatively or in addition, a user can use the gesture of waving a hand to turn off the Smart Outlet and turn on the Smart Outlet by waving a hand in the same or different manner. Because the Smart Outlet also has a dimming function, a user can raise or lower a light level of a lamp connected to the Smart Outlet by moving a hand up or down.

The Smart devices of the system 10 can be controlled remotely using a software application, which may operate on a smart phone, tablet, PC or other computing device. Through the application, a user can remotely control all smart devices and functions of each smart device, as well as the CPU 12 via the network 22. In addition, via the application, a user can remotely view all video camera views of each smart device, whether it be a Smart Switch, Smart Outlet or Smart Sensor, as well as any information shown on any LCD/LED displays and/or the status of each smart device at any time.

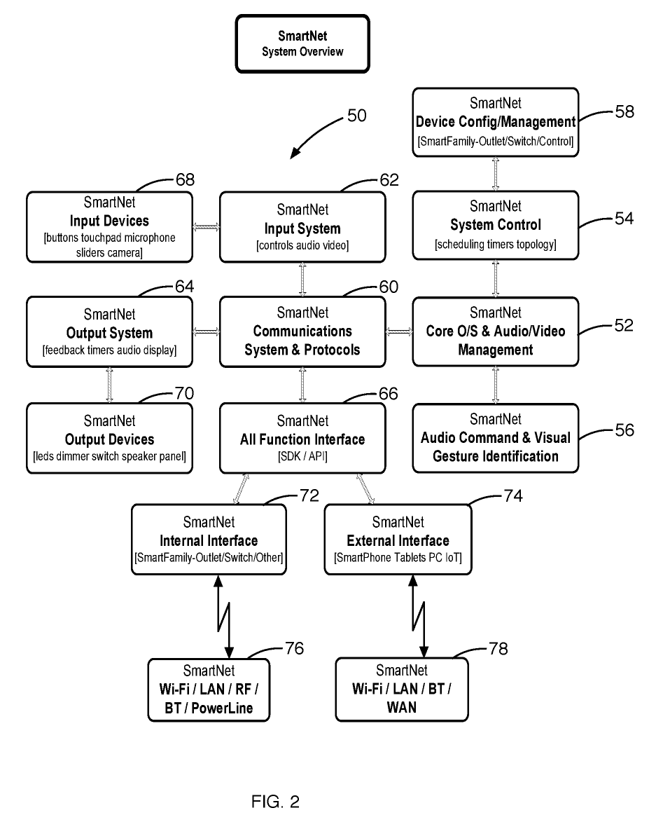

FIG. 2 is a schematic block diagram of a system overview of the SmartNet system, generally indicated at 50, according to the principles of the present invention. SmartNet 50 includes device configuration and management controls for each outlet, switch and sensor in the system. SmartNet 50 also includes system controls for scheduling timers. SmartNet further includes a core operating system and audio/video management, audio command and visual gesture identification. SmartNet also includes communications systems and protocols connected to input systems for receiving input from various input devices (e.g., buttons, touchpads, microphones, sliders and cameras). The communications systems and protocols are also connected to an output system including feedback, timers, audio and display. The output system is connected to various output devices, such as LEDs, dimmers, switches, speakers and other devices. The various functions and features of the SmartNet 50 may be implemented in various hardware and software or firmware components of the system.

The system 50 includes a core operating system and audio/video management protocols module 52. The module 52 is in communication with the system control module 54 and audio command and visual gesture identification module 56. The system control module 52 is in communication with the device configuration and management module 58. The module 52 is also in communication with the communications system and protocols module 60, which in turn is in communication with the input system module 62, output system module 64 and all function interface 66. The input system module 62 is in communication with the various input devices 68. The output system module 64 is in communication with the various output devices 70. The all functions interface 66 is in communication with the internal interface 72, which is in communication with the internal network 76 of the system, and external interface 74, which is in communication with an external network 78 of the system.

The all function interface 66 (e.g., SDI/API) interfaces with internal interface 72 (e.g., Smart Switches, Smart Outlets, Smart Sensors, etc.) and external interfaces 74 (e.g., smart phones, tables, PCs, IOT, etc.). Communication between the SmartNet CPU and the various smart devices through network 76 may be by way of Wi-Fi, LAN, RF, BT and/or power line. Communication between the SmartNet CPU and external interfaces 74 though network 78 may be via Wi-Fi, LAN, BT and/or WAN.

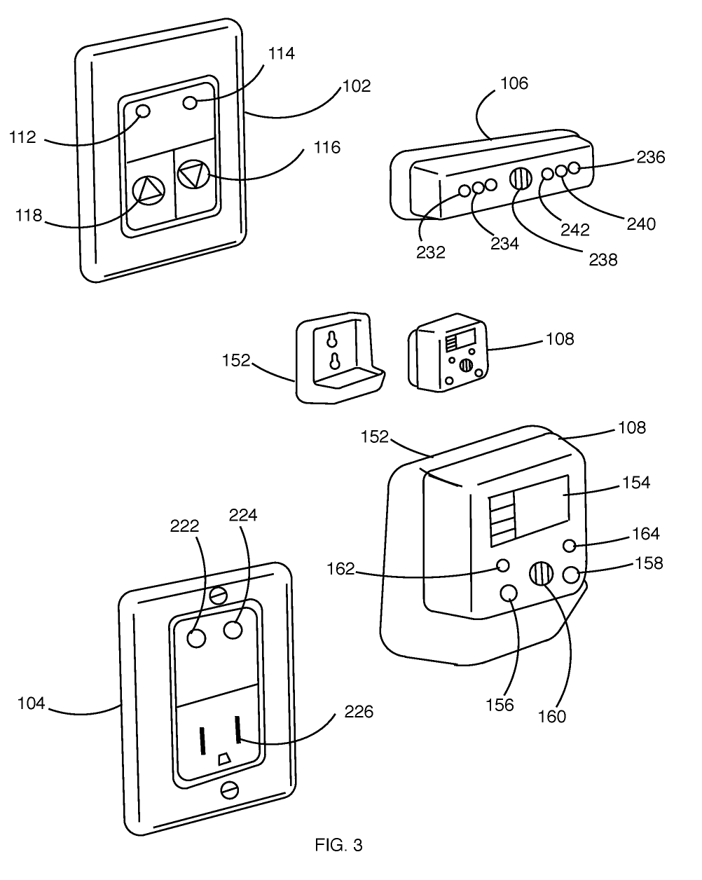

As illustrated in FIG. 3, various Smart devices, including a Smart Switch 102, Smart Outlet 104, Smart Sensor 106 and Smart Net controller 108 can communicate to and with each other via the SmartNet network (as shown in FIG. 1). The Smart Sensor 106 and SmartNet controller 108 may include AC cords, as is known in the art, for connecting to an unswitched AC power outlet. The Smart Switch 102 may include a camera 112 for capturing video images and recognizing control gestures, a status LED light 114, and buttons 116 and 118 for controlling various functions and modes of the Smart Switch as previously described.

Likewise, the Smart Outlet 104 may include a camera 222 for capturing video images and recognizing control gestures and a status LED light 224. The Smart Outlet 104 includes a US standard 120 volts three-pronged electrical outlet 226 that includes polarized plug ports as well as a common ground port. Of course, Smart Outlets for other country standards are also contemplated and are within the scope of the present invention.

The Smart Sensor 106 may be placed in a room where most visible to be able to receive video (e.g., gesture) and audio commands within a room in which the Smart Sensor is installed. The Smart Sensor 106 includes a camera 232, a microphone 234, a status light, a speaker 238, and control buttons 240 and 242. The microphone 234 may comprise a stereo microphone to enhance the accuracy of voice recognition software operating on the system.

The SmartNet controller 108 may include a docking station 152 from which the SmartNet controller 108 may be removed. The docking station 152 may be a charging station, which is connected to electrical power, to charge a battery within the controller 108. The SmartNet controller 108 includes an LCD screen 154 that displays various information regarding the other SmartNet devices in the system, including but not limited to status. The SmartNet Controller includes a camera 156, a microphone 158, a speaker 160, and control buttons 162 and 164.

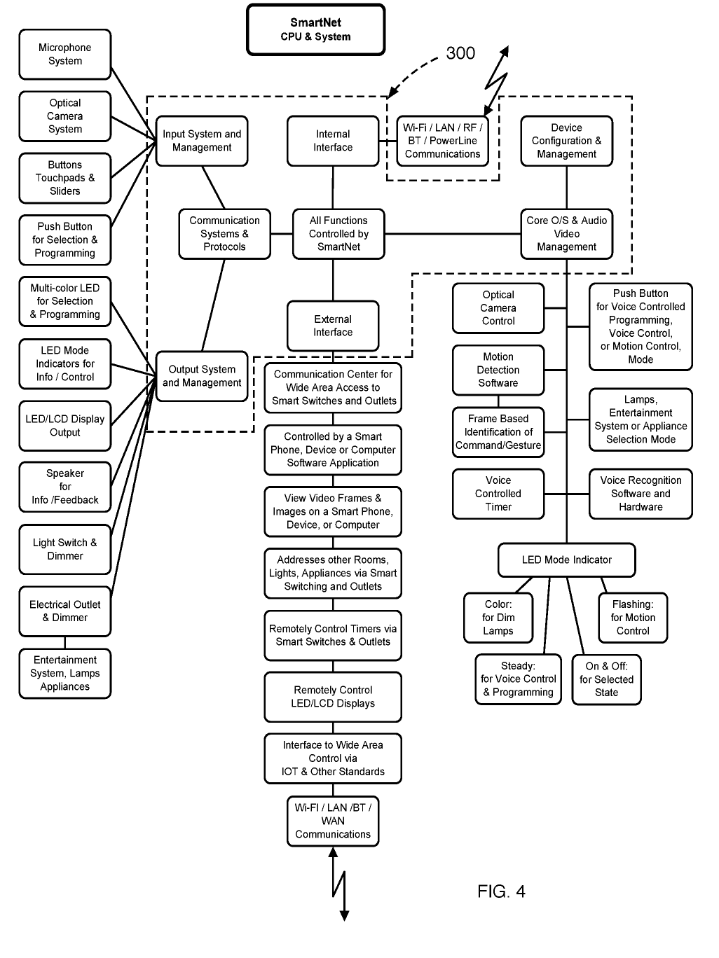

FIG. 4 is a schematic block diagram of the SmartNet CPU and system of the present invention. The CPU is connected to the system via any wired or wireless communication protocol that allows two-way communication between the CPU and the other Smart devices. All functions are controlled by the SmartNet CPU and interact with the other devices of the system either through the Internal Interface or the External Interface. Both input system and management and output system and management are controlled by the CPU. Input system and management includes input from microphones, cameras and manual devices such as buttons, touchpads and sliders. Output system and management includes LED light control, LCD display, speaker output, light switches and dimmers as well as outlets and dimmers. The external interface is used to communicate with Smart Switches, Smart Outlets, Smart Sensors and other smart devices including receiving all information from the various smart devices and sending control signals for the various functions of each smart device. The CPU also includes device configuration and management functions as well as camera control, motion detection, gesture recognition, timers, voice control, user input control, and LED lights status indication.

The CPU 300, represented by dashed lines, includes various operations performed or provided by the CPU 300. These include all functions that are controlled by SmartNet, communication systems and protocols, input system and management, output system and management, internal interface, external interface, Core 0/S and audio/video management and device configuration and management. These CPU operations, provide communication with and between the various external devices with which the CPU 300 is in communication as well as control of such external devices and systems. Thus, the input system is connected to each of the microphone system, optical camera system, buttons, touchpads and sliders of various input devices, and push buttons for function selection and programming of the smart devices. The output system is coupled to LED mode indicators of the smart devices, LED/LCD display outputs, speakers for information and/or feedback, light switches, light dimmers, electrical outlets, electrical dimmers, entertainment systems, lamps and appliances. The external interface of the CPU 300 is connected to a communication center for wide area access to the various smart devices and may be controlled by a smart phone, computing device or computer software applications. When connected, the user can view video frames and images on a smart phone, computing device or computer. In addition, addresses of other rooms, lights and appliances can be accessed via the various smart devices. Likewise, timers can be remotely controlled via other smart devices as well as remote control of LED and/or LCD displays. Interface to wide area control via IOT or other standards are also provided through various wireless communication protocols.

The core O/S and A/V management module provides optical camera control, motion detection, frame based identification of commands and/or gestures, voice controlled timers, push buttons for voice controlled programming, voice control or motion control modes, lamps, entertainment system or appliance selection mode, voice recognition software and hardware, LED mode indicators, including color, and whether on or off or displayed as steady or flashing.

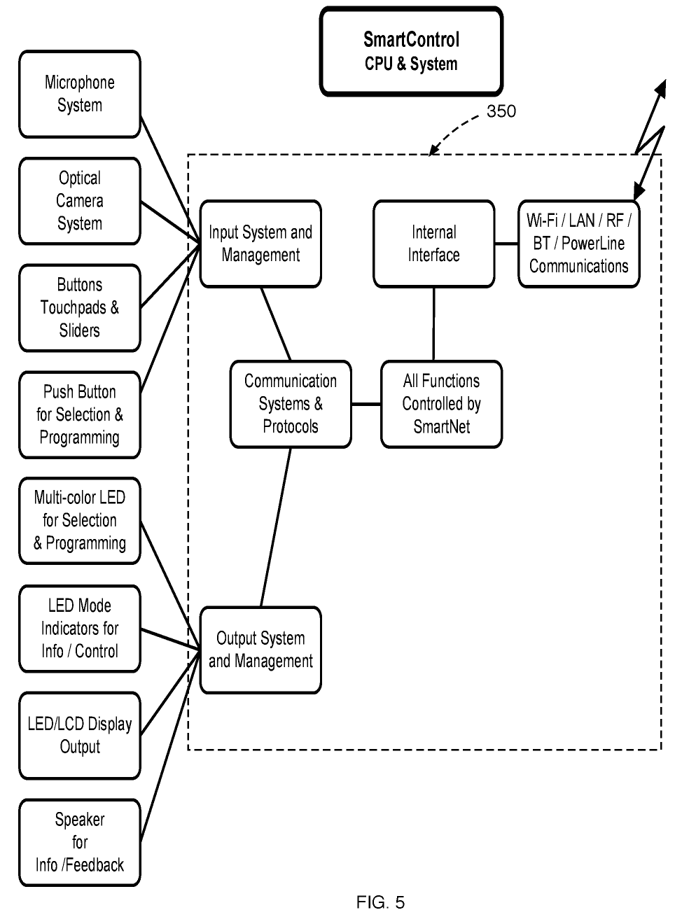

As shown in FIG. 5, the system may include one or more other SmartControl CPUs that control certain functions of the overall system. For example, the system may include a CPU 350 having an internal interface for communication via various wireless or wired protocols in which all such functions are controlled by the CPU 350. The CPU 350 includes communication systems and protocols for receiving various system input signals from microphones, optical cameras, buttons, touchpads and sliders of the system. The CPU also includes communication systems and protocols for sending output signals for controlling LED mode indicators, LED/LCD display output and speakers for information and feedback. The CPU 350 also includes a communications module to communicate with other CPUs of the system, including the main SmartNet CPU previously described.

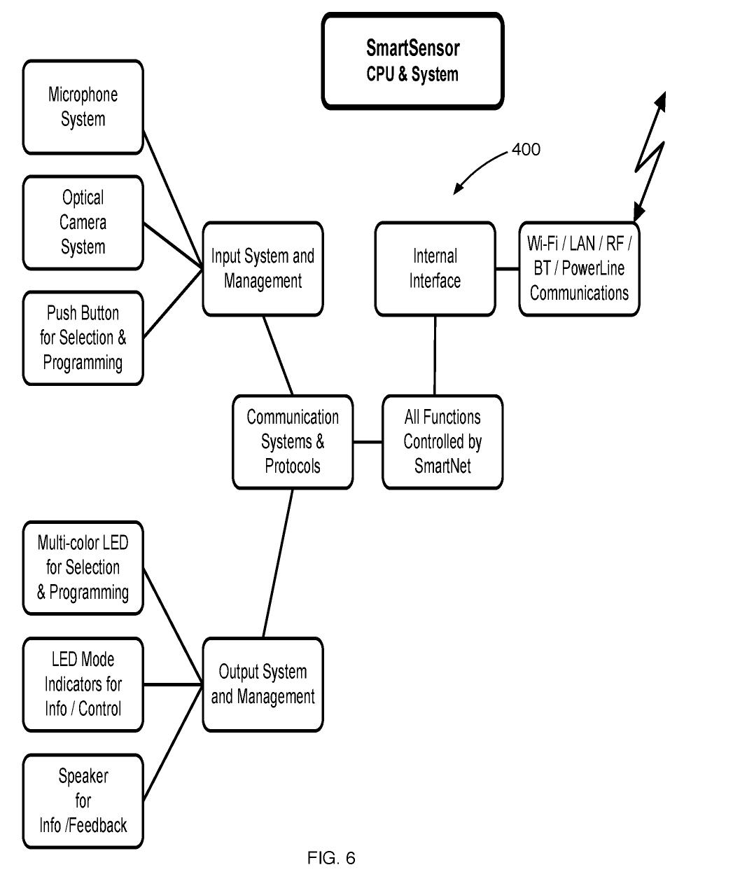

FIG. 6 is a schematic block diagram that illustrates a Smart Sensor 400 of the present invention. The Smart Sensor 400 includes a processor with a communication system and protocols for receiving various input signals from a microphone, optical camera and user input buttons of the Smart Sensor 400 and communicating those signals to the SmartNet CPU. In addition, the processor of the Smart Sensor can control various output functions of the Smart Sensor 400 such as controlling Multi-color LED lights for selection and programming functions, LED mode indicators for information and control and the speaker of audible feedback and information.

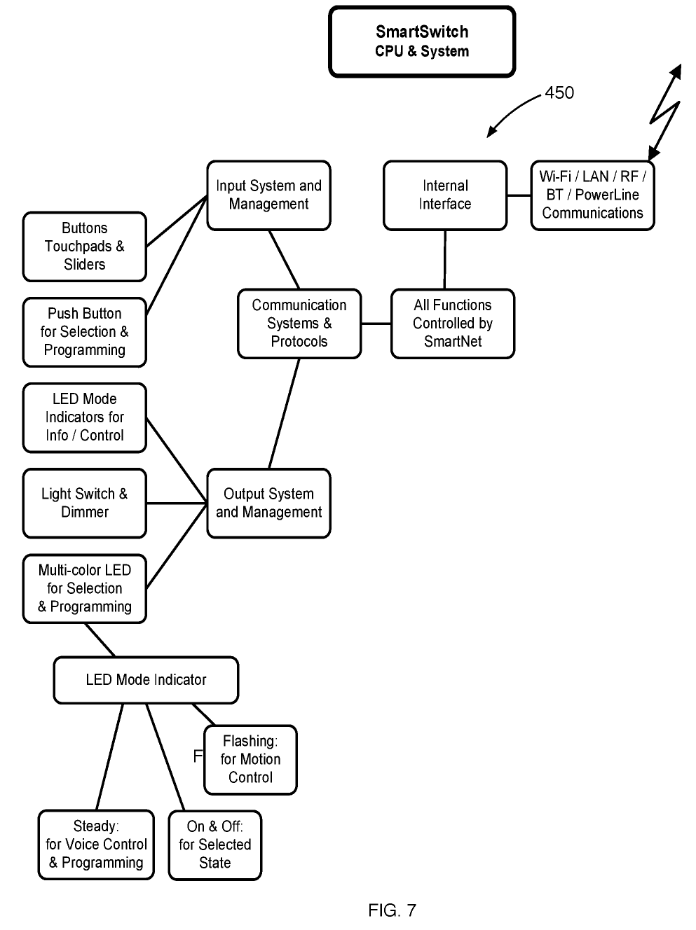

As shown in FIG. 7, a Smart Switch 450 of the present invention includes a processor with a communication system and protocols for receiving various input signals from the user input buttons of the Smart Switch 450 and communicating those signals to the SmartNet CPU. In addition, the processor of the Smart Switch can control various output functions of the Smart Switch 450 such as controlling multicolor LED lights for selection and programming functions, LED mode indicators for information and light switch and dimmer functions. The LED mode indicator may include a flashing mode for motion control, on and off for a selected state and a steady on mode for voice control and programming modes.

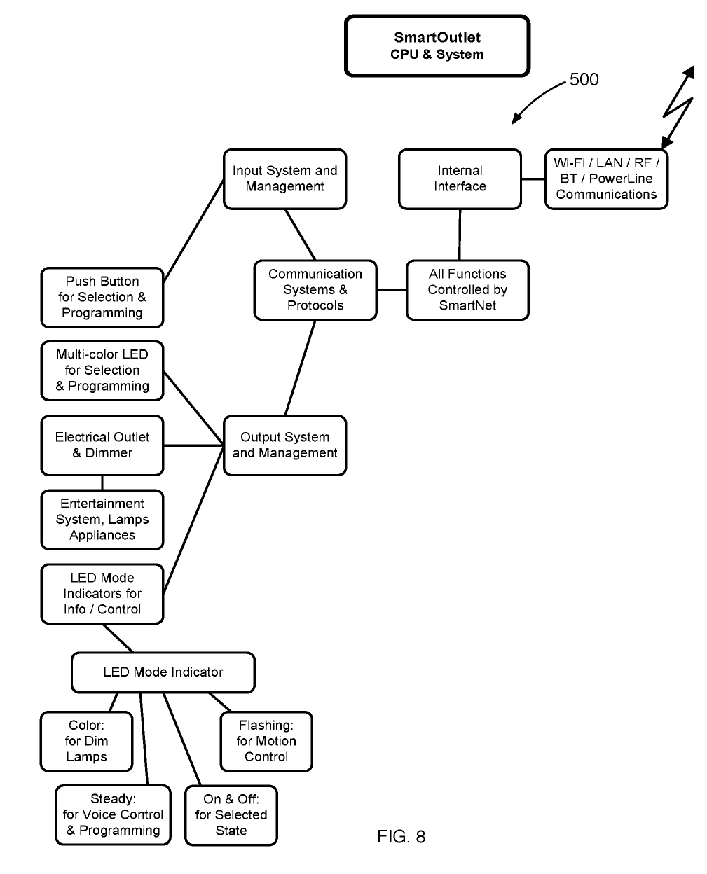

As shown in FIG. 8, the features and functions of a Smart Outlet 500 of the present invention are illustrated. The Smart Outlet 500 includes a processor with a communication system and protocols for receiving various input signals from the user input buttons of the Smart Outlet 500 and communicating those signals to the SmartNet CPU. In addition, the processor of the Smart Outlet can control various output functions of the Smart Outlet such as controlling multicolor LED lights for selection and programming functions, LED mode indicators for information, electrical outlet and dimmer functions, entertainment, lamp and appliance control. The LED mode indicator may include a flashing mode for motion control, on and off for a selected state, a steady on mode for voice control and programming modes and a color mode for the dimming function.

For both the smart outlets and smart switches of the present invention, these smart devices may include single color or multicolor LED indicator lights where, for example, steady green represents voice control mode, flashing green represents voice control programming, steady red represents motion control mode, flashing red indicates motion control programming, steady yellow represents timer mode and flashing yellow represents timer mode programming. Of course, those of skill in the art will understand that other colors and lighting modes may be utilized to indicate various states, such as motion or voice control, of the system.

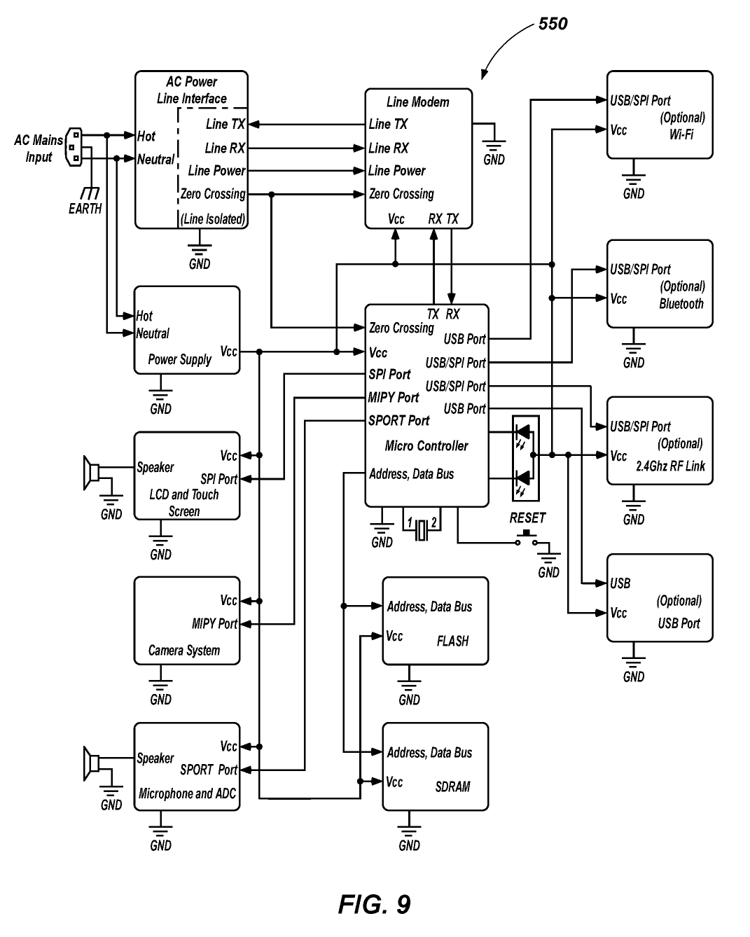

FIG. 9 illustrates a circuit block diagram for the SmartNet CPU. The SmartNet CPU includes a micro controller that is coupled to a line modem for communication with the Smart devices of the system as well as the external devices, such as a smart phone. The SmartNet CPU processor is also coupled to a microphone, camera system and LCD and touch screen. Flash memory and RAM provide storage for firmware, software and information storage. USB ports provide ports for connecting other devices.

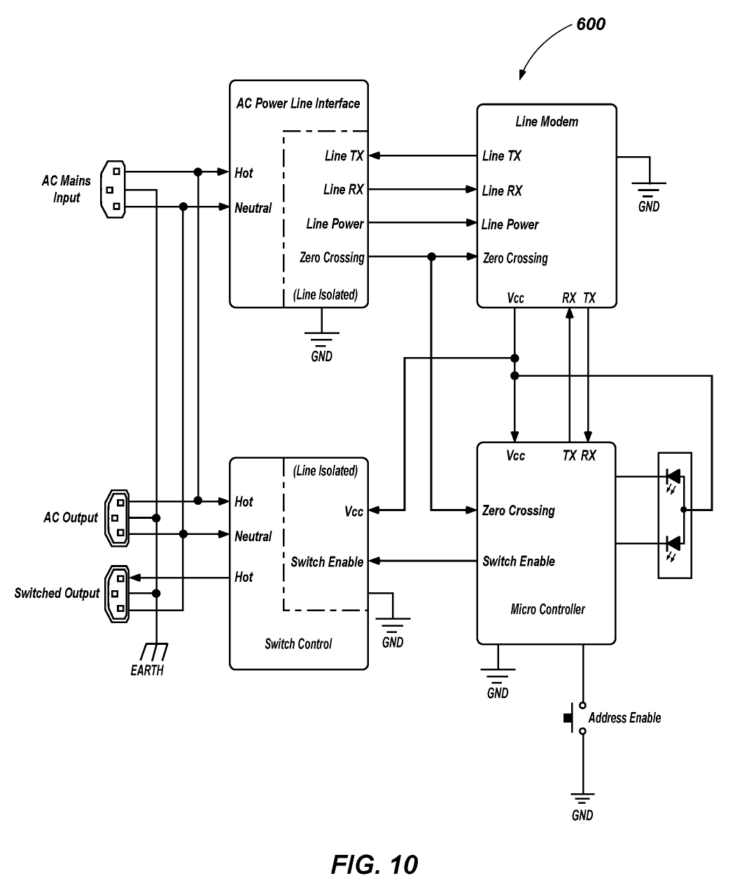

FIG. 10 is a circuit block diagram of a Smart Outlet switched outlet of the present invention. The Smart Outlet includes a micro controller for controlling the various outlet functions and for communicating feedback signals to the SmartNet CPU. The Smart Outlet includes a line modem for interfacing with the SmartNet CPU via an AC power line interface that allows for communication through the electrical lines of the home or building. The microcontroller is also coupled to a switch control to control the AC and switched output of the Smart Outlet.

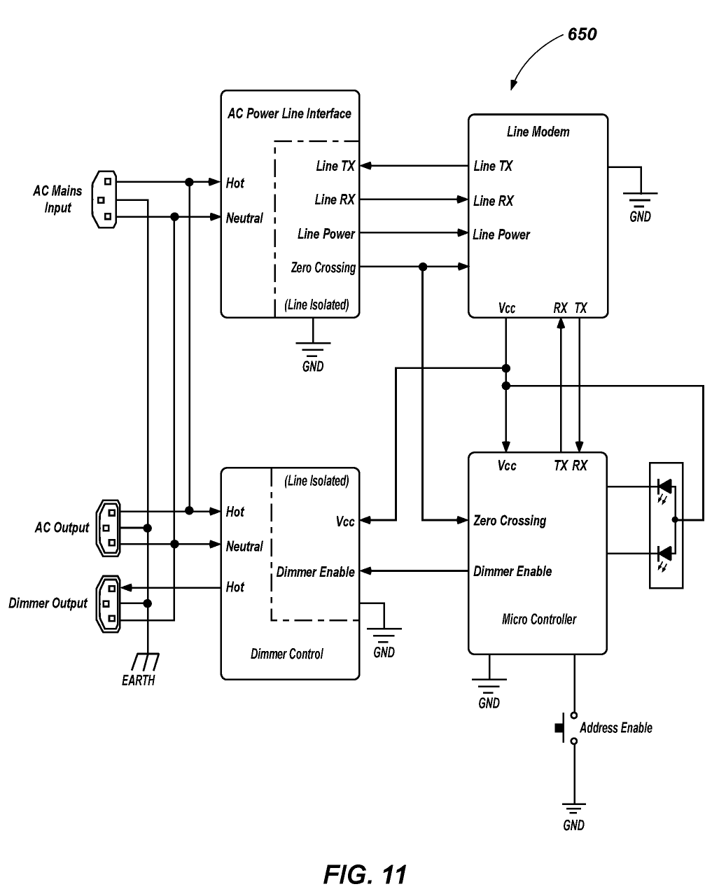

FIG. 11 is a circuit block diagram of a Smart Outlet dimmer outlet 650 of the present invention. The Smart Outlet includes a micro controller for controlling the various outlet functions and for communicating feedback signals to the SmartNet CPU. The Smart Outlet includes a Line Modem for interfacing with the SmartNet CPU via an AC power line interface that allows for communication through the electrical lines of the home or building. The microcontroller is also coupled to a dimmer control to control the AC and dimmer output of the Smart Outlet.

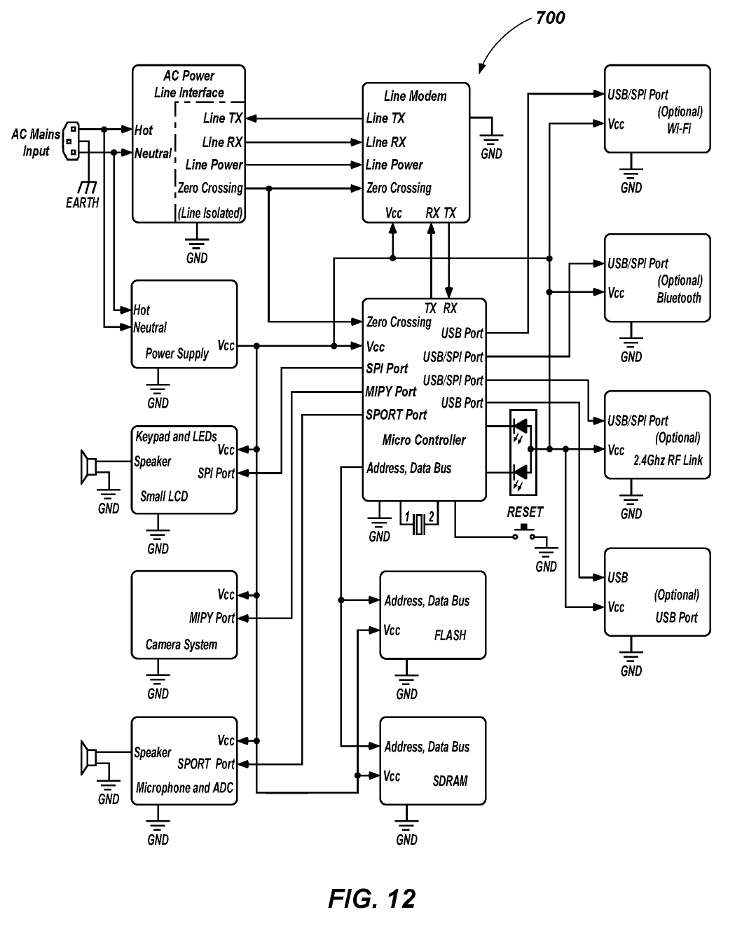

FIG. 12 is a circuit block diagram of a Smart sensor 700 of the present invention. The Smart sensor includes a micro controller for controlling the various sensor functions and for communicating feedback signals to the SmartNet CPU. The Smart sensor includes a Line Modem for interfacing with the SmartNet CPU via an AC power line interface that allows for communication through the electrical lines of the home or building. The microcontroller is also coupled to an internal camera system for motion control and microphone for voice control. The Smart sensor may also include Wi-Fi capability, Bluetooth capability, RF link capability, USB port capability, internal memory as well as a user interface. Because the Smart sensor 700 includes a microcontroller, it can be programmed to operate in both in concert with the SmartNet CPU or independently thereof. For example, while the SmartNet system of the present invention may be operated and controlled by a single SmartNet CPU, each room of the system may include a Smart sensor. The Smart sensor 700 thus has the capabilities of motion and/or voice recognition and can communicate commands received by the Smart sensor 700 to other smart devices within the room and thus control the other smart devices. Any change in state of a smart device by the Smart sensor is also communicated to the SmartNet CPU so that the CPU has real time status information of all smart devices of the system. Thus, just as the SmartNet CPU, the Smart sensor 700 can include voice recognition software and/or software for interpreting motion gestures to control other smart devices in the system. As such, each Smart sensor can be assigned to a group of smart devices that are in proximity to the Smart sensor, such as any smart devices in the same room as a particular Smart sensor. Each Smart sensor in the system thus acts like a mini CPU subsystem within the SmartNet system.

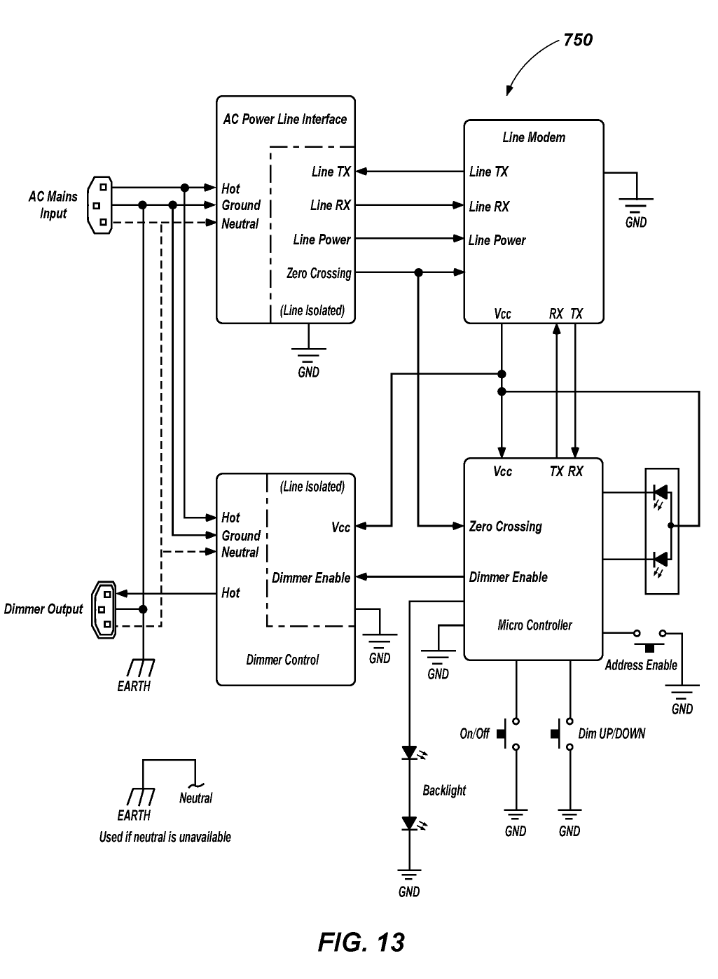

FIG. 13 is a circuit block diagram of a Smart switch dimmer 750 of the present invention. The Smart switch includes a micro controller for controlling the various switch functions and for communicating feedback signals to the SmartNet CPU. The Smart switch includes a Line Modem for interfacing with the SmartNet CPU via an AC power line interface that allows for communication through the electrical lines of the home or building. The microcontroller is also coupled to a dimmer control to control the AC and dimmer output of the Smart switch. The dimmer control may comprise any dimmer circuitry known in the art. For example, the Smart switch dimmer 750 may control a potentiometer of a conventional dimmer circuit in order to control a light level of a light to which the Smart switch dimmer 750 is connected.

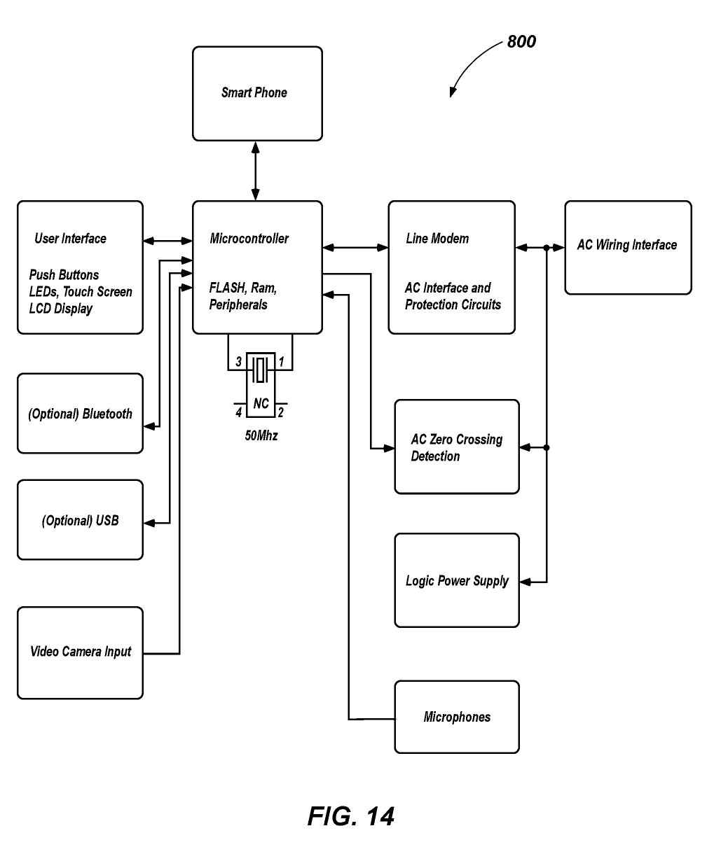

Referring now to FIG. 14, an alternative embodiment of a SmartNet system 800 of the present invention is illustrated in a block diagram. The system 800 is comprised of a microcontroller, which may include FLASH, Ram and peripherals is in communication with a user interface, which may include push buttons, LEDs, touch screen and/or an LCD display. The microcontroller may also include wireless protocol devices, such as wireless devices for providing Bluetooth connectivity, as well as USB connections and a video camera input. The microcontroller also includes a line modem which can be connected the electrical wiring of a house or other building and includes an AC interface and protection circuits. The line modem is connected to an AC wiring interface to connect the system 800 to the hard wiring of the home or building. AC zero crossing detection and a logic power supply is also provided. One or more microphones may also be connected to the microcontroller. The microcontroller may be controlled by application software operated through a smart phone or other handheld computing device.

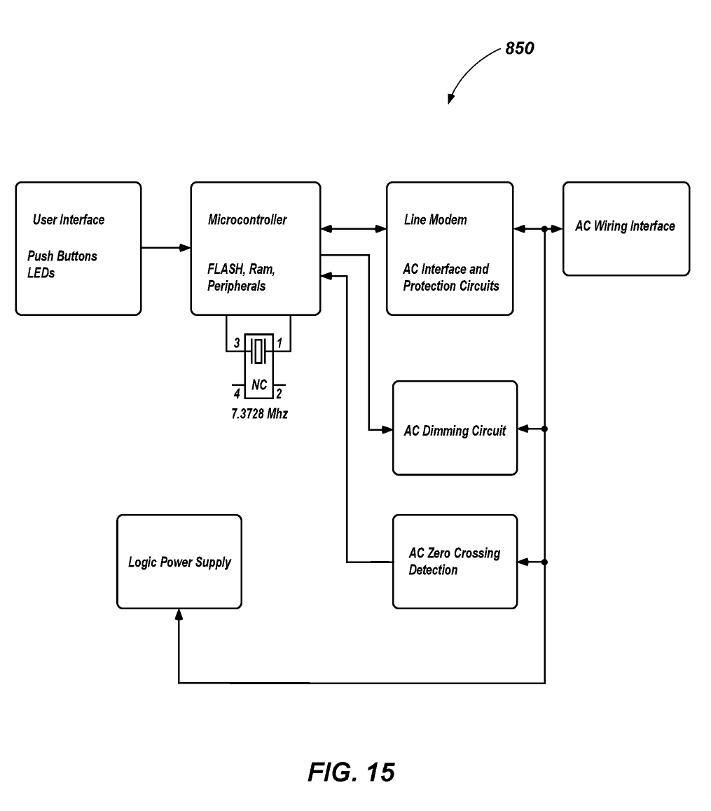

As shown in FIG. 15, a smart switch 850 of the present invention may include some of the same components as the CPU of the SmartNet system. That is, the smart switch 850 may include a microcontroller connected to a user interface, which includes push buttons and LED display lights. In addition, the smart switch 850 includes a line modem with AC interface and protection circuits coupled to an AC wiring interface. An AC dimming circuit is provided to allow dimming control of an appliance or light to which the switch 850 is electrically connected. Also, an AC zero crossing detection module is provided. A logic power supply is also provided to provide power from the switch 850.

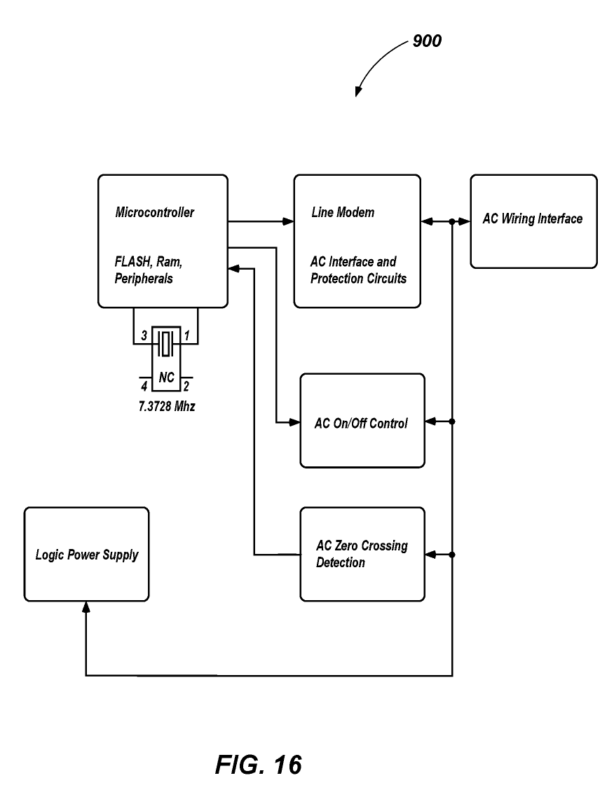

As shown in FIG. 16, a smart outlet 900 of the present invention may include some of the same components as the of the smart switch 850 previously described. That is, the smart outlet 900 may include a microcontroller connected to a line modem with AC interface and protection circuits coupled to an AC wiring interface. An AC on/off control is provided to allow switching control of an appliance or light to which the outlet 900 is electrically connected. Also, an AC zero crossing detection module is provided. A logic power supply is also provided to provide power from the outlet 900.

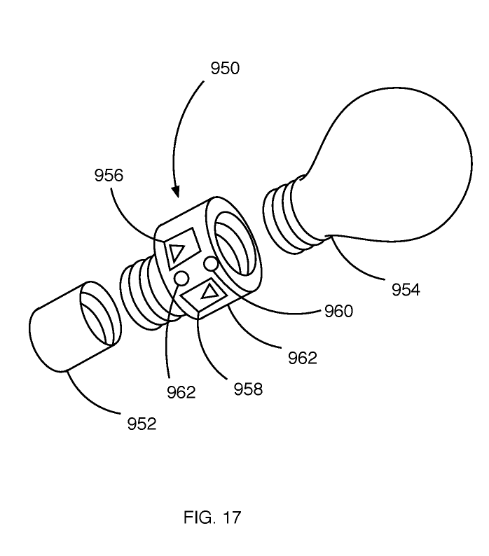

As shown in FIG. 17, it is further contemplated that a smart dimmer switch according to the present invention may be incorporated into a light bulb adapter 950. The adapter 950 is configured to be coupled between a light fixture socket 952 and a light bulb 954. The adapter includes mode, power and dimming switches 956 and 958 as well as an LED mode indicator light 960 to provide a visual display of the mode of operation of the adapter. The adapter 950 also includes a mode control switch 962 that can be pressed by a user to change the mode of operation of the adapter 956, such as from motion control mode to voice control mode or manual control mode. The body 962 of the adapter is configured with a receiving end for receiving an attachment end of a light bulb and an insertion end for coupling with the socket 952. It should be noted that while the adapter 950 is illustrated as being configured to attach between a standard threaded light bulb and a similarly internally threaded socket, the adapter could be configured to accommodate connection between any type of light bulb known in the art and a corresponding socket. In addition, the adapter 950 could be configured to receive a light bulb having one type of connection and a socket having another type of connection.

It is further contemplated that the smart switch can be incorporated into a smart circuit breaker. As with the smart switch described herein, the smart circuit breakers can be controlled by the SmartNet controller with voice and motion control. Thus, for example, the user could speak the words “oven breaker off,” and the smart circuit breaker connected to the oven would switch to the off position. The smart circuit breakers are also configured to be controllable through a smart phone or other handheld computing device. That way, if a user leaves his/her house and is not sure whether the oven was left on, for example, the user could access the system through his/her smart phone and turn the circuit breaker connected to the oven to the “off” position, e.g., by touching an “off” icon. Similarly, the system of the present invention could be configured to turn on or off a central air-conditioning and heating system via a smart phone. For example, if a user went on vacation, he or she could turn the heating and air-conditioning system off until the user is ready to return. Then, several hours prior to returning home, the user could turn the system back on so that the user's home is at the right comfortable temperature upon return.

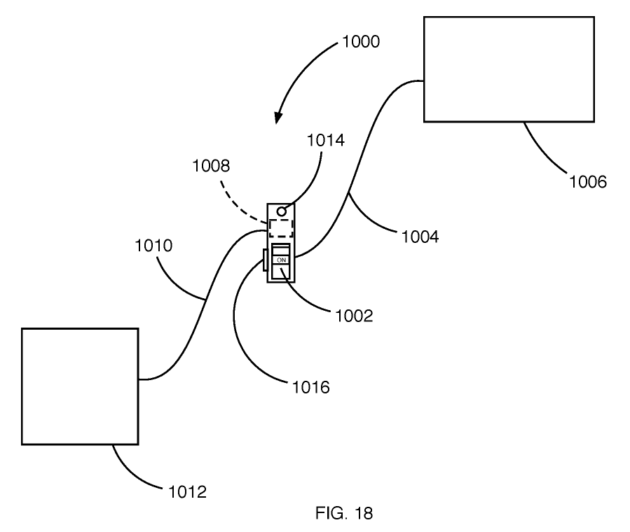

FIG. 18 illustrated a smart circuit breaker 1000 in accordance with the present invention. The smart circuit breaker 1000 includes a manual switch 1002 similar to a conventional circuit breaker and is connected through household wiring 1004 to a household appliance or system 1006, such as an oven or a heating and air conditioning system. The circuit breaker 1000 also includes internal circuitry 1008 for sending and receiving signals through household wiring 1010 to the smart net CPU 1012 of the smart net system to be able to receive command communications from the CPU 1012 in order turn on or off the smart circuit breaker 1000. The smart circuit breaker 1000 also includes an indicator LED light 1014 that indicates whether the switch 1002 is in the on or off position and/or whether the smart circuit breaker 1000 is in a manual mode or being controlled by the smart net CPU 1012. The smart circuit breaker 1000 includes a motor, solenoid or other mechanical or electrical operating device 1016 so that the switch 1002 can be remotely actuated via instructions from the smart net CPU 1012. The instructions may be pre-programmed into the smart net CPU 1012 or sent to the smart net CPU remotely via a smart phone or other computing device.

It is further contemplated that the various smart net devices and features may be incorporated into other electrical devices known in the art, such as in a ceiling fan. For such a ceiling fan, the smart net system of the present invention could be utilized to control fan speed as well as light control and dimming.

In the foregoing specification, the present invention has been described with reference to specific exemplary embodiments. Various modifications and changes may be made, however, without departing from the spirit and scope of the present invention as set forth in the claims, including combinations of elements of the various illustrated embodiments. The specification and figures are illustrative, not restrictive, and modifications are intended to be included within the scope of the present invention. Accordingly, the scope of the present invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages, and solutions to problems have been described above with regard to particular embodiments. Any benefit, advantage, solution to problem, or any element that may cause any particular benefit, advantage, or solution to occur or to become more pronounced are not to be construed as critical, required, or essential features or components of any or all the claims.

The phrase “consisting essentially of” as may be used herein is intended to cover additional elements or functions that do not materially affect the basic and novel characteristics of the claimed invention. Thus, “consisting essentially of” is intended to encompass not only those components specifically listed, but also separate or additional components that do not materially alter the specifically recited functions or elements.

The terms “comprise,” “comprises,” “comprising,” “having,” “including,” “includes,” or any variations of such terms, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

What is claimed is:

1. A home automation system, comprising:
a central processing unit controlling a network in communication with a plurality of smart devices;
the plurality of smart devices comprising one or more of a switch or an outlet; and
each smart device of the plurality of smart devices comprising a processor, a communication device in communication with the central processing unit via the network and a user interface for controlling or setting an operating parameter of the smart device.

2. The system of claim 1, wherein each of the plurality of smart devices can communicate directly with at least one other of the plurality of smart devices.

3. The system of claim 1, wherein the plurality of smart devices further comprises a sensor.

4. The system of claim 3, wherein the sensor comprises a device for detecting a particular gesture and sending a signal to the central processing unit to indicate the particular gesture detected, the central processing unit then controlling another of the plurality of smart devices depending on the signal received by the central processing unit.

5. The system of claim 3, wherein the sensor comprises a device for detecting a particular sound and sending a signal to the central processing unit to indicate the particular sound detected, the central processing unit then controlling another of the plurality of smart devices depending on the signal received by the central processing unit.

6. The system of claim 1, wherein the plurality of smart devices comprises a device for detecting a particular gesture and sending a signal to the central processing unit to indicate the particular gesture detected, the central processing unit then controlling another of the plurality of smart devices depending on the signal received by the central processing unit.

7. The system of claim 1, wherein the plurality of smart devices comprises a device for detecting a particular sound and sending a signal to the central processing unit to indicate the particular sound detected, the central processing unit then controlling another of the plurality of smart devices depending on the signal received by the central processing unit.

8. The system of claim 1, wherein the plurality of smart devices each comprises a microphone for receiving voice commands, the plurality of smart devices configured to relay any voice commands received to the central processing unit and the central processing unit then controlling a smart device in another location based on the voice command received.

9. The system of claim 1, wherein the plurality of smart devices comprises at least one light bulb adapter.

10. The system of claim 6, wherein the device for detecting gestures comprises a video camera.

11. The system of claim 7, wherein the device for detecting sound comprises a microphone.

12. The system of claim 1, wherein the network is connected to electrical hard wiring of a building in which the system is installed and communications between the central processing unit and the plurality of smart devices are exchanged through the electrical hard wiring.

13. The system of claim 1, wherein the central processing unit comprises a user interface for interfacing with the processor, a line modem and an AC wiring interface for communicating with the plurality of smart devices.

14. The system of claim 1, further comprising an AC zero crossing detection device.

15. The system of claim 1, wherein the plurality of smart devices comprises a smart dimming switch comprising an AC dimming circuit, a line modem and an AC wiring interface for communicating with the central processing unit.

16. The system of claim 1, wherein the plurality of smart devices comprises a smart switch comprising an AC on/off control and a line modem and an AC wiring interface for communicating with the central processing unit.

17. A method of controlling lighting and other electronic systems of a home, comprising:
providing a central processing unit in communication with a network;
providing a plurality of electronic control devices in communication with the central processing unit through the network, the plurality of electronic control devices comprising one or more of a controllable switch or a controllable outlet; and
controlling each of the one or more of the controllable switch or the controllable switch using at least one of motion activation or sound activation.

18. The method of claim 17, further comprising providing each of the plurality of electronic control devices with a processor, a communication device in communication with the central processing unit via the network and a user interface for controlling or setting an operating parameter of the electronic control device.

19. The method of claim 17, further comprising providing each of the plurality of electronic control devices with the ability to communicate directly with at least one other of the plurality of electronic control devices.

20. The system of claim 1, wherein the plurality of electronic control devices comprises a device for detecting one of a particular gesture or a particular sound and sending a signal to the central processing unit to indicate the particular gesture or particular sound detected, the central processing unit then controlling another of the plurality of electronic control devices depending on the signal received by the central processing unit.
